(19) United States
(12) Patent Application Publication
(10) Pub. No.: US 2026/0188851 A1
(43) Pub. Date: Jul. 2, 2026

(54) POUCH CELL SERVICE LOOP

(71) Applicant: Wisk Aero LLC, Mountain View, CA (US)

(72) Inventors: Jacob Ryser, Mesa, AZ (US); Sytse Tacoma, Christchurch (NZ); Travis Orloff, San Jose, CA (US)

(73) Assignee: Wisk Aero LLC, Mountain View, CA (US)

(21) Appl. No.: 19/434,328

(22) Filed: Dec. 29, 2025

Related U.S. Application Data
(60) Provisional application No. 63/739,234, filed on Dec. 27, 2024.
(60) Provisional application No. 63/773,296, filed on Mar. 17, 2025.

(51) Int. Cl. H01M 50/503; H01M 50/105; H01M 50/211; H01M 50/242; H01M 50/516

(52) U.S. Cl. CPC H01M 50/503; H01M 50/105; H01M 50/211; H01M 50/242; H01M 50/516

(57) ABSTRACT

Systems and methods of the present disclosure provide a service loop for a pouch cell tab by bending the service loop into the cord length at the cell-level. Embodiments of the present disclosure reduces the risk of cell damage or open circuit welds. Both failure modes have the potential to open circuit a battery mid-operation or trigger a thermal runaway. According to various embodiments, the service loop is integral to the pouch such that no additional parts are used to form the pouch cell.

### CROSS-RELATED APPLICATIONS

This application claims priority to Provisional Ser. No. 63/739,234, “Pouch Cell Service Loop,” and further claims priority to Provisional Ser. No. 63/773,296, “Pouch Cell Service Loop” which are incorporated herein by reference in their entirety for all purposes.

### BACKGROUND

Pouch cells are lithium-ion batteries having a generally flat, pouch-shaped design that are widely used in various applications such as automotive, consumer electronics, energy storage, electric vehicles, or the like. In some configurations, pouch cells are constructed using a flexible, multilayered laminate including an anode, a cathode, and a separator. Electrodes within the pouch cell are coated with a conductive material and the separator prevents direct contact between the electrodes. The flexible pouch is sealed to a form a compact unit having a higher energy density compared to other battery types.

### BRIEF SUMMARY

Systems and methods of the present disclosure are related to pouch cells and are particularly related to pouch cell service loops.

Systems and methods of the present disclosure provide a service loop for a pouch cell tab by bending the service loop into the cord length at the cell-level. Embodiments of the present disclosure reduces the risk of cell damage or open circuit welds. Both failure modes have the potential to open circuit a battery mid-operation or trigger a thermal runaway. According to various embodiments, the service loop is integral to the pouch such that no additional parts are used to form the pouch cell.

According to one embodiment, a battery module includes a current collector and a plurality of pouch cells. Each of the plurality of pouch cells includes a stack including a cathode, an anode, and a service loop comprising a first portion extending from the stack orthogonal to the current collector and a second portion extending in a same plane as the current collector. One of the first portion and the second portion comprises at least one groove.

The battery module may include various optional embodiments. The first portion may include the at least one groove and the at least one groove may be disposed between the pouch cell and the current collector. The second portion may include the at least one groove and the at least one groove may be disposed along a top surface of the current collector. The second portion of each of the plurality of pouch cells may be coupled to the current collector along a length of the current collector. The second portion of each of the plurality of pouch cells may be coupled to the current collector via a welded joint. Each of the plurality of pouch cells may be operable to independently move within the battery module. The at least one groove may be configured to straighten under tension. Each of the plurality of pouch cells may include a cell tab extending above the cathode and the anode of the stack. The service loop may extend from the cell tab. The plurality of pouch cells may be coupled to the current collector in series. The plurality of pouch cells may be coupled to the current collector in parallel. Each of the service loops may be integral to the respective pouch cell. The service loop of each of the plurality of pouch cells may be free of a welded joint.

According to another embodiment, a pouch cell includes a stack including a cathode, an anode, and a service loop including a first portion extending from the stack orthogonal to a second portion. The first portion includes at least one groove and the at least one groove is disposed between the pouch cell and a bend between the first portion and the second portion.

The pouch cell may include various optional embodiments. The service loop may be integrally formed within the stack of the pouch cell. The pouch cell may include a cell tab extending above the cathode and the anode of the stack. The service loop may extend from the cell tab. The at least one groove may be configured to straighten under tension. The service loop of each of the plurality of pouch cells may be free of a welded joint.

According to yet another embodiment, a method of manufacturing includes forming a stack including a cathode, an anode, and a service loop extending from the stack. The method further includes forming at least one groove along the service loop between a first portion and a second portion of the service loop and bending the second portion of the service loop toward a direction orthogonal to the first portion of the service loop.

The method may include various optional embodiments. The method may further include providing a current collector and coupling the second portion of the service loop to the current collector for forming a battery module. Forming the at least one groove may include guiding the service loop between a pair of corresponding rollers.

### BRIEF DESCRIPTION OF THE DRAWINGS

A further understanding of the nature and advantages of various embodiments may be realized by reference to the following figures. In the appended figures, similar components or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

FIG. 1A illustrates a simplified, isometric view of an example battery pack, according to at least one example.

FIG. 1B illustrates an exploded, isometric view of the battery pack of FIG. 1A, according to at least one example.

FIG. 2 is an exemplary pouch cell with a service loop, according to various embodiments of the present disclosure.

FIG. 3 is a flowchart of a method of manufacturing for pouch cells having service loops, according to various embodiments of the present disclosure.

FIG. 4 illustrates an exemplary manufacturing process for pouch cells having service loops, according to various embodiments of the present disclosure.

FIG. 5A is an exemplary pouch cell having a service loop, according to various embodiments of the present disclosure.

FIG. 5B is an assembly of exemplary pouch cells having service loops, according to various embodiments of the present disclosure.

FIG. 6 is an alternative implementation of an exemplary pouch cell having a service loop, according to various embodiments of the present disclosure.

FIG. 7 illustrates various assemblies of exemplary pouch cells having service loops, according to various embodiments of the present disclosure.

The figures depict various embodiments of the present disclosure for purposes of illustration only. One skilled in the art will readily recognize from the following discussion that alternative embodiments of the structures and methods illustrated herein may be employed without departing from the principles of the disclosure described herein.

### DETAILED DESCRIPTION

The figures and the following description relate to various embodiments by way of illustration only. It should be noted that from the following discussion, alternative embodiments of the structures and methods disclosed herein will be readily recognized as viable alternatives that may be employed without departing from the principles of the claimed embodiments.

Reference will now be made in detail to several embodiments, examples of which are illustrated in the accompanying figures. It is noted that wherever practicable similar or like reference numbers may be used in the figures and may indicate similar or like functionality. The figures depict embodiments for purposes of illustration only. One skilled in the art will readily recognize from the following description that alternative embodiments of the structures and methods illustrated herein may be employed without departing from the principles of the embodiments described herein.

Pouch cells have a positive sheet metal electrode and a negative sheet metal electrode or “cell tab.” Pouch cells may be connected to other pouch cells in series or parallel to build voltage and ampacity. The cell tab carries current and is not configured to be mechanically or physically loaded in any way. Loading the cell tabs may cause either internal damage to the pouch cell or rupture the joint between cell tabs and the element the cell tab is joined to. Typically, cell tabs are welded to a current collector, which is a rigid element electrically common to many cells to build the desired series and parallel count. Shock and vibration-prone environments prevalent in traction applications pose a threat to the cell tab being loaded. Conventionally available service loops in traction battery packs are formed from additive process where a ribbon or wire bond is welded in place between the cell terminal and the current collector. These existing solutions are vulnerable to failed weld (e.g., the weld fails under physical load), especially after vibration loading during flight.

According to various embodiments of the present disclosure, a service loop is employed to mitigate the risk of cell tab loading. A service loop as described herein may be a deviation in the cord of the cell tab to allow a small amount of relative motion between the cell body and the current collector without loading the cell tab. Embodiments of the present disclosure describe a service loop integral to the pouch cell tab by bending the service loop into the cord length at the cell-level. Systems and methods described herein reduce the risk of cell damage or open circuit welds. Pouch cells having service loops according to various embodiments may be implemented into any battery system including pouch cells, particularly those in a shock or vibration-prone environment.

Embodiments of the present disclosure provide a service loop that is incorporated into the stack of the pouch cell. According to various embodiments, the service loop is integral to the pouch cell. For example, the service loop is free of a welded joint. Said another way, the service loop is not welded to the pouch cell in any way. The service loop is secured within the stack via any one of or combination of heat, pressure, sealing, etc. Embodiments of the present disclosure further increase the integrity of the battery module as there are no dissimilar (metal) bonds that weaken the system. For example, conventional systems include a first weld between a connector and a pouch cell and a second weld between the connector and a current collector. Such welds often include welding dissimilar materials and these welds are more likely to break and result in failure of the pouch cell.

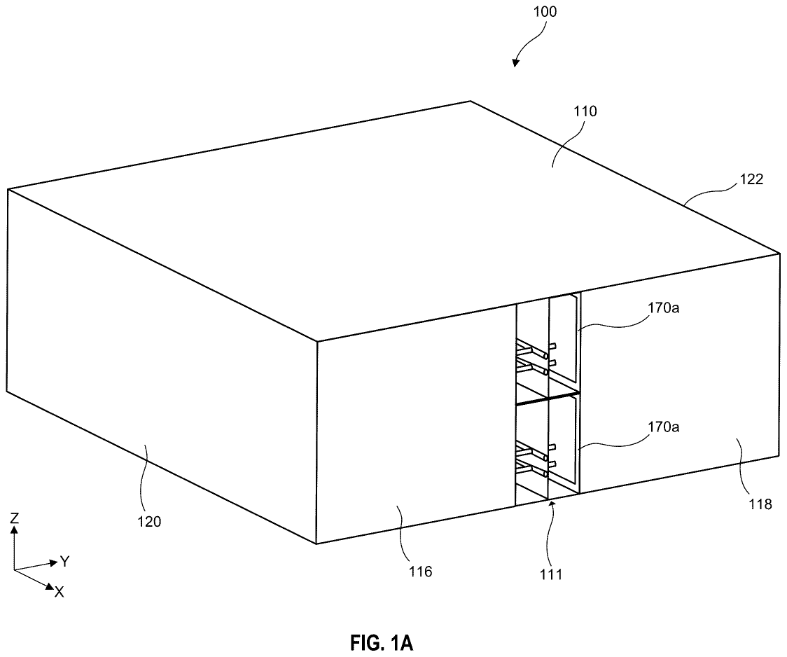

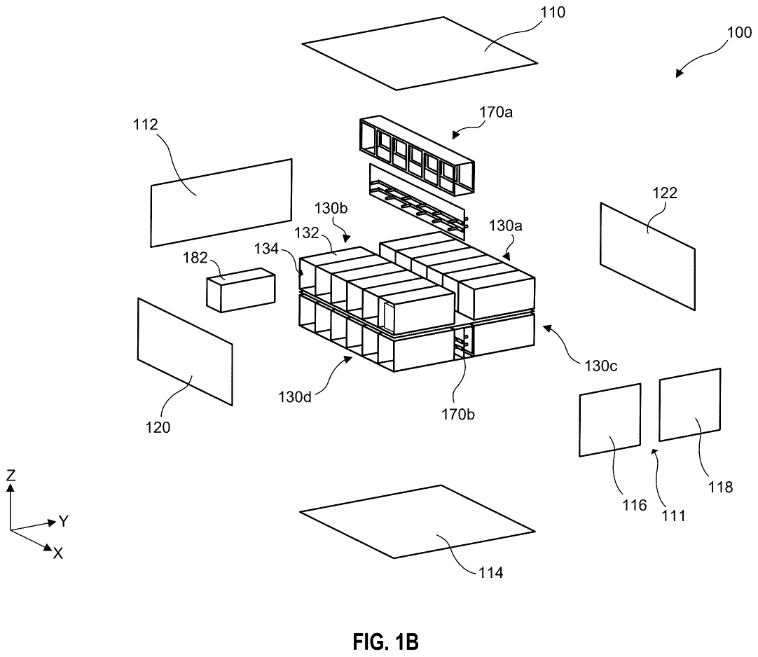

FIGS. 1A and 1B depict an example battery pack 100. With specific reference to FIG. 1B, the battery pack 100 can define an enclosure formed by a first panel 110, a second panel 112, a third panel 114, a fourth panel 116, a fifth panel 118, a first sidewall 120, and a second sidewall 122. The panels 112, 114, 116, 118 may be coupled together (e.g., via welding, brazing, soldering, gluing, fastening, or the like) to define an interior volume. The panels 110, 112, 114, 116, 118 and sidewalls 120, 122 may define the enclosure to have a substantially cuboid structure, however, in other embodiments, the enclosure may have other shapes, such as being pyramid, spherical, or the like. It should be understood that, for the sake of visual clarity, the battery pack 100 may include additional components not depicted in FIGS. 1A and 1B.

The interior volume may house internal components of the battery pack 100, such as sets of battery modules 132. For example, the enclosure may house a first module row 130a of battery modules 132, a second module row 130b of battery modules 132, a third module row 130c of battery modules 132, and a fourth module row 130d of battery modules 132. Each battery module 132 may define a battery volume 134 sized and shaped to house a grouping 182 of battery cells such that each module row 130a, 130b, 130c, 130d. Each grouping 182 of battery cells can include battery cells grouped together in a stacked configuration, wound configuration, or the like. Although each module row 130a, 130b, 130c, 130d is depicted as including six battery modules 132, in other embodiments, one or more of the module rows can have more or less than six battery modules, such as four battery modules, five battery modules, seven battery modules, eight battery modules, or the like. In other embodiments, the battery modules of each module row may not be oriented in a linear row but, instead, may be oriented as a set of battery modules in a set of non-linear orientation.

The battery pack 100 can include a first venting system 170a positioned between the module rows 130a, 130b and a second venting system 170b positioned between the module rows 130c, 130d. The battery modules 132 of each of the module rows 130a, 130b, 130c, 130d may be coupled to the corresponding venting system 170a, 170b (e.g., via welding, brazing, soldering, gluing, fastening, or the like) such that an airtight seal is formed between each battery module 132 and the corresponding venting system 170a, 170b. The battery modules 132 may be coupled directly with the corresponding venting system 170a, 170b to form this airtight seal. However, in other embodiments, one or more intervening component(s) (e.g., including a gasket, seal ring, or the like) may be positioned between the battery module and the corresponding venting system to form the airtight seal. The first venting system 170a can be in fluid communication with the module rows 130a, 130b through the airtight seal such that effluent discharge may flow through the first venting system 170a and an exit opening 111 defined between the panels 116, 118 to exterior of the battery pack 100. The second venting system 170b can be in fluid communication with the module rows 130c, 130d through the airtight seal such that effluent discharge may flow through the second venting system 170b and the exit opening 111 defined between the panels 116, 118 to exterior of the battery pack 100.

According to various embodiments, the grouping 182 of batteries within the battery module 132 includes a plurality of pouch cells. The pouch cells may be electronically coupled to one another within the grouping 182. Conventional assemblies of pouch cells include welding pouch cell tabs to busbars for forming electrical connections. Embodiments of the present disclosure provide service loops that are adapted to withstand shock and vibration-prone environments. A service loop as described herein enables an amount of relative motion between the cell body and the current collector without loading the cell tab, thereby mitigating risk of failure of the pouch cell.

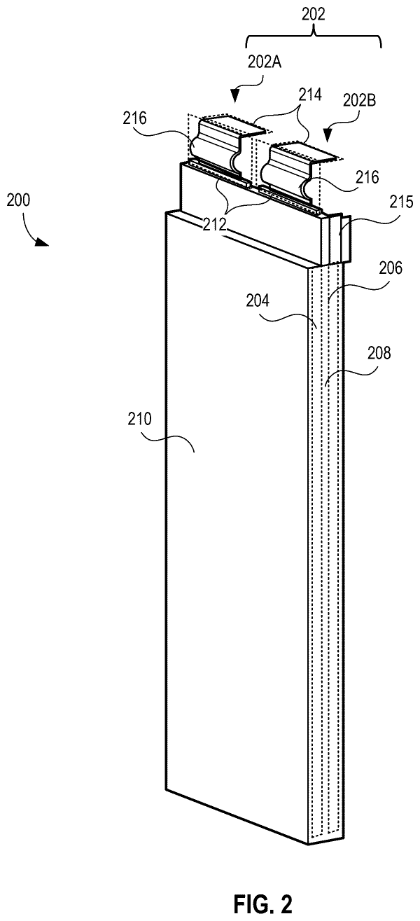

FIG. 2 is an exemplary pouch cell with a service loop. As shown in FIG. 2, pouch cell 200 includes two service loops 202A and 202B (collectively, service loops 202). A service loop 202 may interchangeably be referred to herein as a cell tab, a service tab or a service extension. Pouch cell 200 may include one service loop 202, at least two service loops 202, at least three service loops 202, at least four service loops 202, etc. For example, a wider pouch cell may use a plurality of service loops while a narrower pouch cell may use a single service loop as would be appreciated by one having ordinary skill in the art upon reading the present disclosure.

According to various embodiments, the pouch cell 200 may include one or more cathodes 204 and one or more anodes 206. According to some embodiments, an anode 206, the negative element, may include graphite or other carbon-based material and the cathode 204, the positive element, may include a metal oxide or phosphates. In some embodiments, the pouch cell 200 may further include a separator 208 or a porous membrane immersed in an electrolyte or the like for forming an electrode within the pouch cell 200.

In some embodiments, the layers of the pouch cell 200 (e.g., the one or more cathodes 204, the one or more anodes 206, any separator(s) 208, etc.) may be wrapped or otherwise sealed within the pouch 210 of the pouch cell 200. For example, a stack of layers within the pouch cell 200 may include alternative between a cathode 204, a separator 208, and an anode 206. The pouch 210 may include a flexible, laminated foil that encases these internal components. The pouch 210 may include layers of aluminum and plastic, according to some embodiments. In various embodiments, the pouch 210 is relatively flexible and is configured to protect the internal components. The pouch 210 may be sealed using heat and pressure to prevent electrolyte leakage. In some embodiments, the pouch 210 is sealed to form a cell tab 215 portion. A service loop 202 according to the present disclosure extends from the cell tab 215 of the pouch cell 200.

Embodiments of the present disclosure provide service loops 202 that extend from the pouch cell 200 and are adapted to enable some relative movement of the battery cells during shock or vibration events. Accordingly, the service loops 202 as provided herein are less susceptible to wear and tear or other damaging events that would otherwise results in failure of the pouch cell 200. Each service loop 202 may include a first portion 212 and a second portion 214. The first portion 212 and the second portion 214 may be equal lengths (e.g., the service loop 202 is divided in half) according to some embodiments. In other embodiments, the first portion and the second portion 214 are not the same length. The service loop 202 includes at least one groove 216. In some embodiments, the at least one groove 216 may be along the first portion 212 as shown in FIG. 2. In other embodiments, the at least one groove 216 may be along the second portion 214. In yet other embodiments, the at least one groove 216 may be between the first portion 212 and the second portion 214. These embodiments are discussed in further detail below with respect to other figures.

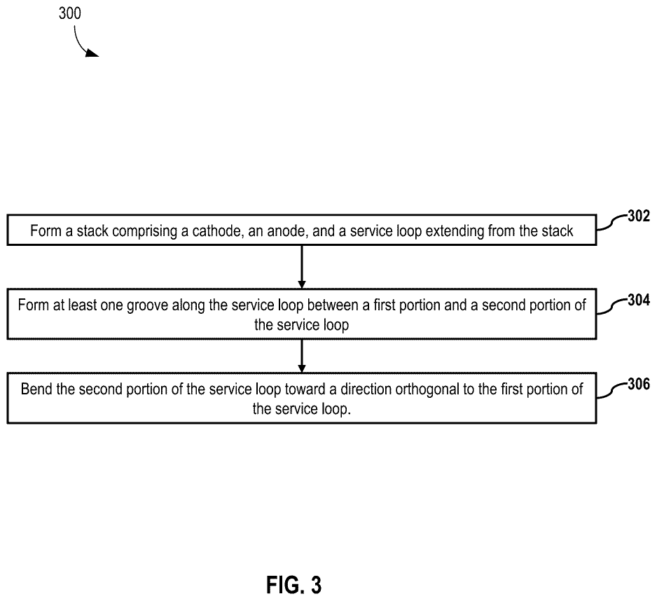

FIG. 3 is a flowchart of a method of manufacturing for pouch cells having service loops. Process 300 may include more or less operations than those described herein. Furthermore, operations as described herein may be performed in alternative orders than those described herein unless explicitly noted otherwise. Block 302 includes forming a stack including at least an anode, a cathode, and a service loop extending from the stack. According to various embodiments, block 302 may include stacking the services loop within the layers of the cathode(s), separator(s), and anode(s), injecting an electrolyte into the stack, and sealing the stack of layers within a pouch to form the pouch cell. The service loop may extend from the stack from any position between layers of the stack. For example, a stack may include a plurality of cathodes and anodes, and the service loop may extend from anywhere within the stack of cathodes and anodes.

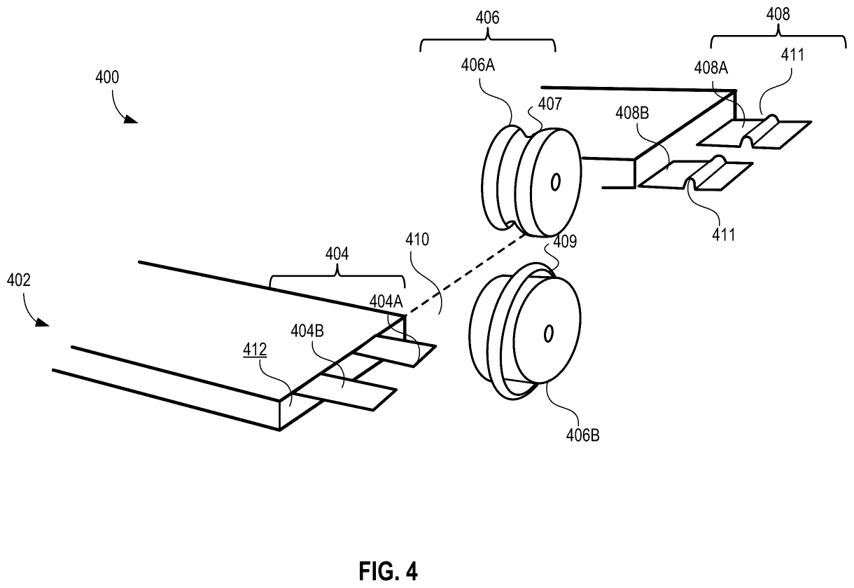

Block 304 includes forming at least one groove along the service loop between a first portion and a second portion of the service loop. The service loop may include a first portion and a second portion. The service loop includes at least one groove. The at least one groove may be formed between the first portion and the second portion or the at least one groove may be formed in one or both of the first portion and the second portion. Block 304 may include guiding or otherwise feeding the service loop between a series or a pair of rollers as shown in further detail in FIG. 4. For example, a first roller may have an extended portion that fits into a corresponding indented portion of a second roller. Accordingly, a portion of the service loop is sandwiched between the rollers and the groove is formed therein.

Embodiments of the present disclosure provide a service loop that is incorporated into the stack of the pouch cell. According to various embodiments, the service loop is integral to the pouch cell. For example, the service loop is free of a welded joint. Said another way, the service loop is not welded to the pouch cell in any way. The service loop is secured within the stack via any one of or combination of heat, pressure, sealing, etc. Embodiments of the present disclosure further increase the integrity of the battery module as there are no dissimilar (metal) bonds that weaken the system. For example, conventional systems include a first weld between a connector and a pouch cell and a second weld between the connector and a current collector. Such welds often include welding dissimilar materials and these welds are more likely to break and result in failure of the pouch cell.

Block 306 includes bending the second portion of the service loop toward a direction orthogonal to the first portion of the service loop. The bending may be a 90-degree bend between the first portion and the second portion, according to some embodiments. In other embodiments, the bend may be less than 90 degrees or greater than 90 degrees. The bend may be formed at the at least one groove such that the first portion is entirely perpendicular (or otherwise bent) relative to the second portion. In other embodiments, the bend is formed at one side of the groove such that the bend is formed in the first portion or the second portion. Bending may be performed by any metal bending technique such as press braking, rolling bending, rotary bending, wipe bending, swivel bending, etc.

Further embodiments of the process 300 may include forming a battery module by coupling one or more formed pouch cells with a current connector (e.g., busbar), to be shown and described in further detail below. A portion of the service loop may be welded or otherwise coupled to the current connector according to various embodiments. Embodiments of the present disclosure reduce the number of welds required for assembly a battery module and further reduce the weight of the battery module where the service loops extend from the stack of the pouch cell rather than being individually welded to the pouch cell as in conventional systems.

FIG. 4 illustrates an exemplary manufacturing process for pouch cells having service loops. Manufacturing process 400 illustrates a pouch cell 402 having two strips 404A and 404B (collectively, strips 404). The strips 404 extend from within the pouch cell 402 such that the strips 404 may be rolled between rollers 406A and 406B (collectively, rollers 406) such that the strips 404 are pressed to form the service loops 408A and 408B (collectively, service loops 408). A service loop 408 may include at least one groove 411. In at least some embodiments, the service loops 408 may include at least two grooves 411, at least three grooves 411, etc.

In some embodiments, and as shown in FIG. 4, a first roller 406A includes an indented channel 407 that corresponds to an extended portion 409 of a second roller 406B such that the strips 404 are compressed and bent between the indented channel 407 and the extended portion 409 as the rollers 406 translate along a direction 410 transverse to a surface 412 from which the strips 404 extend. Other processes for bending the strips 404 may be implemented as would be appreciated by one having ordinary skill in the art upon reading the present disclosure.

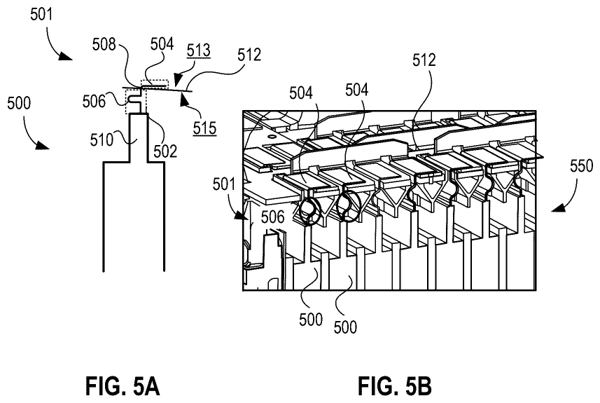

FIG. 5A is an exemplary pouch cell having a service loop. A pouch cell 500 includes a service loop 501. The service loop 501 may include a first portion 502, a second portion 504, and at least one groove 506. As shown in FIG. 5A, the service loop 501 includes a bend 508 between the first portion 502 and the second portion 504. In particular, the service loop 501 as shown in FIG. 5A includes a bend 508 between the at least one groove 506 and the second portion 504. In other embodiments, the bend 508 may be between the first portion 502 and the at least one groove 506. The first portion 502 extends from the pouch cell 500 (e.g., from a cell tab 510 of the pouch cell 500) orthogonal to a current collector 512 and the second portion 504 extends in a same plane as the current collector 512. The second portion 504 may be coupled to a top surface 513 of the current collector 512. The second portion 504 may be coupled to the current collector 512 via welding or any manner known in the art. In other embodiments, the second portion 504 may be coupled to a bottom surface 515 of the current collector 512.

According to various embodiments, the at least one groove 506 of the service loop 501 is configured to straighten under tension. For example, in a shock or vibration event to the pouch cell 500, the pouch cell 500 may move around within a battery module, such as battery module 132. The at least one groove 506 provides an amount of give with the service loop 501 that prevents breakage of the service loop 501. The at least one groove 506 can straighten out in response to a force pulling the pouch cell 500 downward. The at least one groove 506 can further fold into itself in response to the pouch cell 500 being directed upward. According to various embodiments each pouch cell 500 may be operable to independently move within the battery module.

FIG. 5B is an assembly of exemplary pouch cells having service loops. FIG. 5B is an assembly 550 of pouch cells 500. As shown in FIG. 5B, the second portion 504 of each of the pouch cells 500 is coupled to the current collector 512 along a length of the current collector 512. Each of the pouch cells 500 (e.g., each of the second portions 504) may be coupled to the current collector 512 via a welded joint or the like. The pouch cells 500 may be coupled to the current collector 512 in series or the pouch cells 500 may be coupled to the current collector 512 in parallel.

Each of the pouch cells 500 is operable to independently move within the assembly 550. For example, the pouch cells 500 are only coupled to the current collector 512 at the second portion 504 and the pouch cells 500 are not coupled to each other. Accordingly, the pouch cells may move up and down (or to the sides) independently which further prevents breakage of the service loops 501 and failure of the pouch cells 500. The grooves 506 may straighten and bend, thereby increasing the relative movement of the pouch cells 500. This is in contrast to conventional pouch cells where the pouch cells are welded together at one point (such that failure of one weld likely results in failure of all the welds) or conventional pouch cells that break under tension during shock or vibration events. The services loops as provided herein provide at between 0.1 mm and 2.0 mm of additional possible relative movement of the pouch cells 500. Furthermore, embodiments of the present disclosure reduce the amount of rubbing and friction between the pouch cells as the pouch cells are able to individually and independently move within the battery module.

Embodiments of the present disclosure advantageously do not use orthogonal welds. Conventional pouch cells are ultrasonically welded to the current collector. Ultrasonic welding requires access to both sides of the weld between the current collector/tabs of the pouch cells. Battery pack configurations make it difficult to clamp both sides of the connection and create the ultrasonic welds. In contrast, embodiments of the present disclosure may utilize laser welding techniques that weld the service loop to the current collector with access to one side of the connection. Accordingly, the service loop as described herein may be implemented into any battery design, regardless of the welding technique used. This contributes to the independent movement of the battery modules that mitigates the risk of breaking the service loop during shock or vibration events.

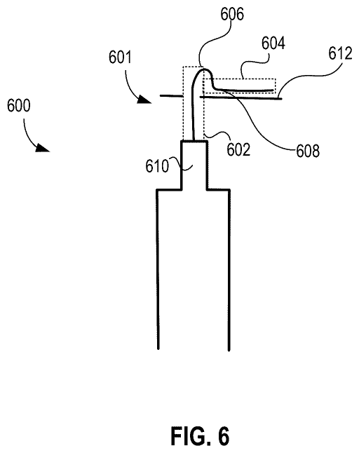

FIG. 6 is an alternative implementation of an exemplary pouch cell having a service loop. A pouch cell 600 includes a service loop 601. The service loop 601 may include a first portion 602, a second portion 604, and at least one groove 606. As shown in FIG. 6, the service loop 601 includes a bend 608 between the first portion 602 and the second portion 604. In particular, the service loop 601 as shown in FIG. 6 includes a bend 608 between the first portion 602 and the second portion 604. In other embodiments, the bend 508 may be between the at least one groove 606 and the second portion 604. The first portion 602 extends from the pouch cell 600 (e.g., from a cell tab 610 of the pouch cell 600) orthogonal to a current collector 612 and the second portion 604 extends in a same plane as the current collector 612. The second portion 604 may be coupled to the current collector 612 via welding or any manner known in the art.

According to various embodiments, the at least one groove 606 of the service loop 601 is configured to straighten under tension. For example, in a shock or vibration event to the pouch cell 600, the pouch cell 600 may move around within a battery module, such as battery module 132. The at least one groove 606 provides an amount of give with the service loop 501 that prevents breakage of the service loop 601. The at least one groove 606 can straighten out in response to a force pulling the pouch cell 600 downward. The at least one groove 606 can further fold into itself in response to the pouch cell 600 being directed upward. According to various embodiments each pouch cell 600 may be operable to independently move within the battery module.

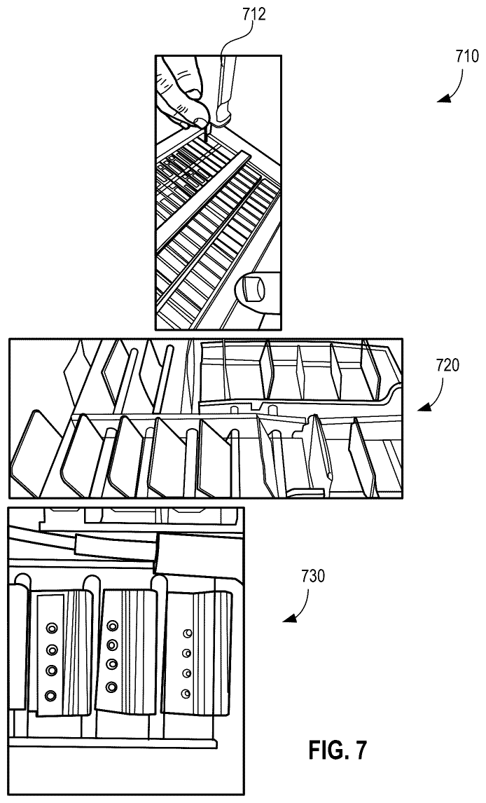

FIG. 7 illustrates various assemblies of exemplary pouch cells having service loops. FIG. 7 illustrates further manufacturing processes for pouch cells having service loops. Sub-process 710 including using a manual tool 712 for seating the service loops of the pouch cells. FIG. 7 further illustrates a sub-process 720 for providing a plurality of pouch cells having service loops such that the service loops are arranged in parallel or otherwise aligned for use in a battery pack or the like. FIG. 7 further illustrates a sub-process 730 illustrating a service loop design and manufacturing process.

### EXAMPLES

Example 1: A battery module includes a current collector and a plurality of pouch cells. Each of the plurality of pouch cells includes a stack including a cathode, an anode, and a service loop comprising a first portion extending from the stack orthogonal to the current collector and a second portion extending in a same plane as the current collector. One of the first portion and the second portion includes at least one groove.

Example 2: A battery module according to example 1, where the first portion includes the at least one groove and the at least one groove is disposed between the pouch cell and the current collector.

Example 3: A battery module according to any of examples 1-2, where the second portion includes the at least one groove and the at least one groove is disposed along a top surface of the current collector.

Example 4: A battery module according to any of examples 1-3, where the second portion of each of the plurality of pouch cells is coupled to the current collector along a length of the current collector.

Example 5: A battery module according to example 4, where the second portion of each of the plurality of pouch cells is coupled to the current collector via a welded joint.

Example 6: A battery module according to any of examples 1-5, where each of the plurality of pouch cells is operable to independently move within the battery module.

Example 7: A battery module according to any of examples 1-6, where the at least one groove is configured to straighten under tension.

Example 8: A battery module according to any of examples 1-7, where each of the plurality of pouch cells further includes a cell tab extending above the cathode and the anode of the stack. The service loop extends from the cell tab.

Example 9: A battery module according to any of examples 1-8, where the plurality of pouch cells are coupled to the current collector in series.

Example 10: A battery module according to any of examples 1-9, where the plurality of pouch cells are coupled to the current collector in parallel.

Example 11: A battery module according to any of examples 1-10, where each of the service loops is integral to the respective pouch cell.

Example 12: A battery module according to any of examples 1-11, where the service loop of each of the plurality of pouch cells is free of a welded joint.

Example 13: A pouch cell includes a stack including a cathode, an anode, and a service loop including a first portion extending from the stack orthogonal to a second portion. The first portion includes at least one groove and the at least one groove is disposed between the pouch cell and a bend between the first portion and the second portion.

Example 14: A pouch cell according to example 13, where the service loop is integrally formed within the stack of the pouch cell.

Example 15: A pouch cell according to any of examples 13-14, further including a cell tab extending above the cathode and the anode of the stack. The service loop extends from the cell tab.

Example 16: A pouch cell according to any of examples 13-15, where the at least one groove is configured to straighten under tension.

Example 17: A pouch cell according to any of examples 13-16, where the service loop of each of the plurality of pouch cells is free of a welded joint.

Example 18: A method of manufacturing includes forming a stack including a cathode, an anode, and a service loop extending from the stack. The method further includes forming at least one groove along the service loop between a first portion and a second portion of the service loop and bending the second portion of the service loop toward a direction orthogonal to the first portion of the service loop.

Example 19: A method according to example 18, further including providing a current collector and coupling the second portion of the service loop to the current collector for forming a battery module.

Example 20: A method according to examples 18-19, where forming the at least one groove comprises guiding the service loop between a pair of corresponding rollers.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments as defined in the appended claims.

Upon reading this disclosure, those of skill in the art will appreciate still additional alternative designs for the system. Thus, while particular embodiments and applications of the present disclosure have been illustrated and described, it is to be understood that the claimed embodiments are not limited to the precise construction and components disclosed herein and that various modifications, changes and variations which will be apparent to those skilled in the art may be made in the arrangement, operation and details of the method and apparatus of the present disclosure disclosed herein without departing from the spirit and scope of the disclosure as defined in any claims drawn to the subject matter herein.

What is claimed is:

1. A battery module comprising:
a current collector; and
a plurality of pouch cells, each of the plurality of pouch cells comprising a stack comprising:
a cathode;
an anode; and
a service loop comprising a first portion extending from the stack and a second portion extending in a same plane as the current collector, wherein one of the first portion and the second portion comprises at least one groove.

2. The battery module of claim 1, wherein the first portion extends from the stack orthogonal to the current collector.

3. The battery module of claim 1, wherein the first portion comprises the at least one groove and the at least one groove is disposed between the pouch cell and the current collector.

4. The battery module of claim 1, wherein the second portion comprises the at least one groove and the at least one groove is disposed along a top surface of the current collector.

5. The battery module of claim 1, wherein the second portion of each of the plurality of pouch cells is coupled to the current collector along a length of the current collector.

6. The battery module of claim 5, wherein the second portion of each of the plurality of pouch cells is coupled to the current collector via a welded joint.

7. The battery module of claim 1, wherein each of the plurality of pouch cells is operable to independently move within the battery module.

8. The battery module of claim 1, wherein the at least one groove is configured to straighten under tension.

9. The battery module of claim 1, wherein each of the plurality of pouch cells further comprises a cell tab extending above the cathode and the anode of the stack, wherein the service loop extends from the cell tab.

10. The battery module of claim 1, wherein each of the service loops is integral to the respective pouch cell.

11. The battery module of claim 1, wherein the service loop of each of the plurality of pouch cells is free of a welded joint.

12. A pouch cell comprising:
a stack comprising:
a cathode;
an anode; and
a service loop comprising a first portion extending from the stack orthogonal to a second portion, wherein the first portion comprises at least one groove and the at least one groove is disposed between the pouch cell and a bend between the first portion and the second portion.

13. The pouch cell of claim 12, wherein the service loop is integrally formed within the stack of the pouch cell.

14. The pouch cell of claim 12, further comprising a cell tab extending above the cathode and the anode of the stack, wherein the service loop extends from the cell tab.

15. The pouch cell of claim 12, wherein the at least one groove is configured to straighten under tension.

16. The pouch cell of claim 12, wherein the service loop is free of a welded joint.

17. A method of manufacturing comprising:
forming a stack for a battery cell, the stack comprising:
a cathode;
an anode; and
a service loop extending from the stack;
forming at least one groove along the service loop between a first portion and a second portion of the service loop; and
bending the second portion of the service loop toward a direction orthogonal to the first portion of the service loop.

18. The method of claim 17, further comprising:
providing a current collector; and
coupling the second portion of the service loop to the current collector for forming a battery module.

19. The method of claim 17, wherein forming the at least one groove comprises guiding the service loop between a pair of corresponding rollers.

20. A battery formed according to the method of manufacturing of claim 17.
